(19) United States
(12) Patent Application Publication
(10) Pub. No.: US 2009/0317965 A1
(43) Pub. Date: Dec. 24, 2009

(54) ELECTRICAL CONTACT FOR TERMINATING A COAXIAL CABLE

(75) Inventors: Edmund Luther Jacobs, Harrisburg, PA (US); Robert Neil Mulfinger, York Haven, PA (US)

Correspondence Address: ROBERT J. KAPALKA;TYCO TECHNOLOGY RESOURCES, 4550 NEW LINDEN HILL ROAD, SUITE 140, WILMINGTON, DE, 19808, US

(73) Assignee: Tyco Electronics Corporation, Berwyn, PA (US)

(21) Appl. No.: 12/145,196

(22) Filed: Jun. 24, 2008

(51) Int. Cl. H01R 9/05

(52) U.S. Cl. 438/578

(57) ABSTRACT

An electrical contact is provided for terminating an electrical conductor of a coaxial cable. The electrical contact includes a body having a first element extending between a cable receiving end portion and a contact portion. The first element includes a first surface configured to engage the electrical conductor. A second element extends from the cable receiving end portion of the first element. The second element includes a second surface configured to engage the electrical conductor. The first and second elements are configured to hold a portion of the electrical conductor therebetween such that the coaxial cable extends outwardly from the cable receiving end portion of the first element.

### BACKGROUND OF THE INVENTION

The subject matter described and/or illustrated herein relates generally to electrical connectors for coaxial cables, and, more particularly, to electrical contacts for terminating coaxial cables.

Due to their favorable electrical characteristics, coaxial cables and connectors have grown in popularity for interconnecting electronic devices and peripheral systems. Coaxial cable connectors typically include an inner electrical contact coaxially disposed within an outer electrical contact of an electrically conductive housing, with a dielectric material separating the inner and outer electrical contacts. The inner electrical contact terminates the end of an inner electrical conductor of the coaxial cable, while the electrically conductive housing terminates an outer electrical conductor of the coaxial cable that is coaxial with the inner electrical conductor. The outer electrical conductor of the coaxial cable and the electrically conductive housing of the coaxial cable connector typically serve as the ground path.

The electrical contacts of coaxial cable connectors that terminate the end of the inner electrical conductor of coaxial cables typically include a body that extends between a cable receiving end that receives the inner electrical conductor and a contact end portion that includes a plug or receptacle contact configured to engage a receptacle or plug contact, respectively, of another coaxial cable connector. The body includes a pair of contact elements that are angled with respect to one another prior to engagement with the inner electrical conductor of the coaxial cable. Specifically, at least some known electrical contacts of coaxial cable connectors include a first contact element that extends between the cable receiving end portion and the contact portion of the body, and a second element that extends outwardly from the contact end portion of the first element. To terminate the inner electrical conductor to the electrical contact, the inner electrical conductor of the coaxial cable is positioned between the first and second elements and the first and second elements are brought together using a crimping operation such that the inner electrical conductor is held securely therebetween. However, the geometry of at least some known electrical contacts for coaxial cable connectors, such as, but not limited to, the exemplary geometry described above, may require specific tools and/or multiple crimping operations to complete termination of the coaxial cable to the coaxial cable connector.

There is a need for a coaxial cable connector that enables a coaxial cable to be more easily terminated to the coaxial cable connector.

### BRIEF DESCRIPTION OF THE INVENTION

In one embodiment, an electrical contact is provided for terminating an electrical conductor of a coaxial cable. The electrical contact includes a body having a first element extending between a cable receiving end portion and a contact portion. The first element includes a first surface configured to engage the electrical conductor. A second element extends from the cable receiving end portion of the first element. The second element includes a second surface configured to engage the electrical conductor. The first and second elements are configured to hold a portion of the electrical conductor therebetween such that the coaxial cable extends outwardly from the cable receiving end portion of the first element.

In another embodiment, an electrical connector is provided for terminating an electrical conductor of a coaxial cable. The electrical connector includes an electrically conductive housing, an insulating member held by the housing, and an electrical contact held by the insulating member. The electrical contact includes a body having a first element extending between a cable receiving end portion and a contact portion. The first element includes a first surface configured to engage the electrical conductor. A second element extends from the cable receiving end portion of the first element. The second element includes a second surface configured to engage the electrical conductor. The first and second elements are configured to hold a portion of the electrical conductor therebetween such that the coaxial cable extends outwardly from the cable receiving end portion of the first element.

### BRIEF DESCRIPTION OF THE DRAWINGS

FIG. 1 is a perspective view of an exemplary embodiment of an electrical connector illustrating the electrical connector terminating the end of a coaxial cable.

FIG. 2 is another perspective view of the electrical connector and coaxial cable shown in FIG. 1.

FIG. 3 is a cross-sectional view of the electrical connector and coaxial cable shown in FIGS. 1 and 2 taken along line 3-3 of FIG. 1.

FIG. 4 is a perspective view of an exemplary alternative embodiment of an electrical connector illustrating the electrical connector terminating the end of a coaxial cable.

FIG. 5 is a cross-sectional view of the electrical connector and coaxial cable shown in FIG. 4 taken along line 5-5 of FIG. 4.

FIG. 6 is a perspective view of an exemplary embodiment of an electrical contact of the electrical connector shown in FIGS. 1-3.

FIG. 7 is a perspective view of an exemplary alternative embodiment of an electrical contact.

FIG. 8 is a perspective view of the electrical contact shown in FIG. 6 illustrating the electrical contact in partial engagement with an electrical conductor of the coaxial cable.

FIG. 9 is a perspective view of the electrical contact shown in FIGS. 6 and 8 illustrating the electrical contact terminating the electrical conductor of the coaxial cable.

FIG. 10 is another perspective view of the electrical contact shown in FIGS. 6, 8 and 9 illustrating the electrical contact terminating the electrical conductor of the coaxial cable.

### DETAILED DESCRIPTION OF THE INVENTION

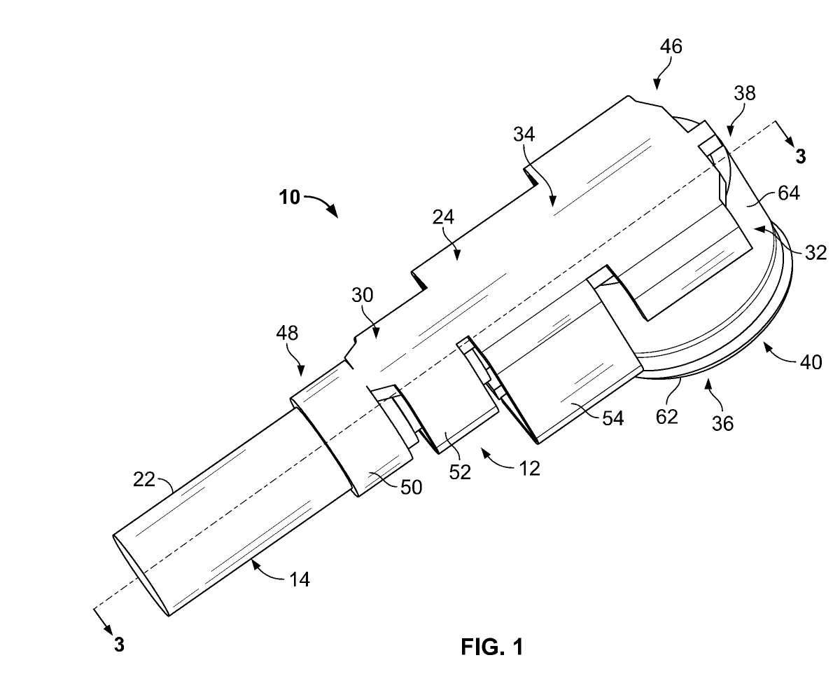

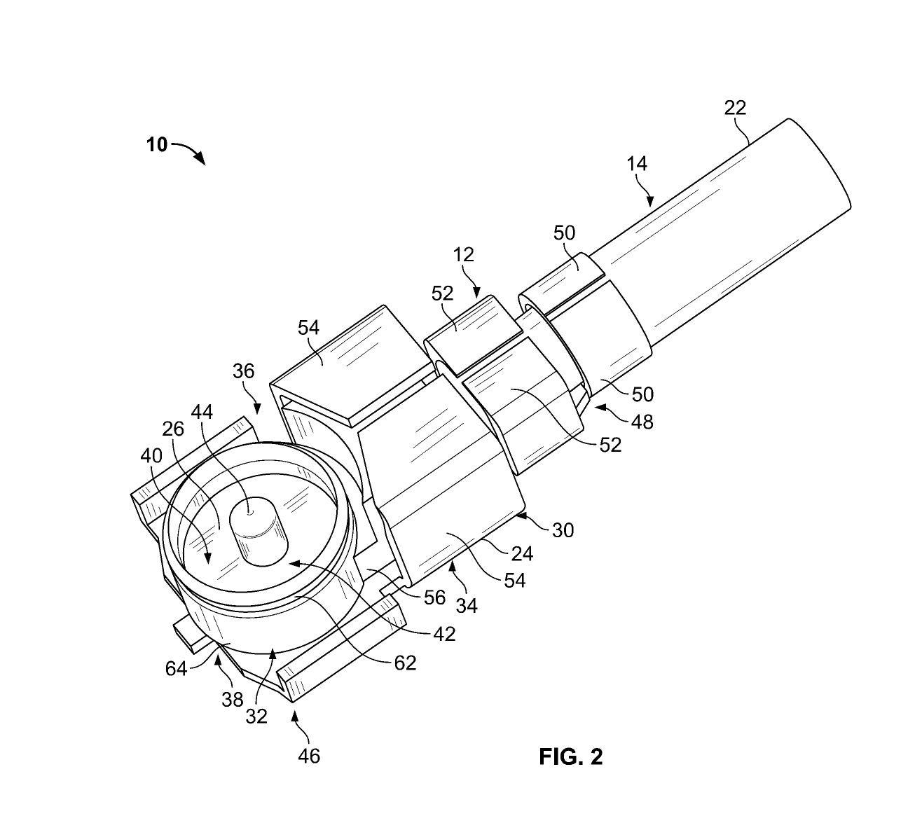

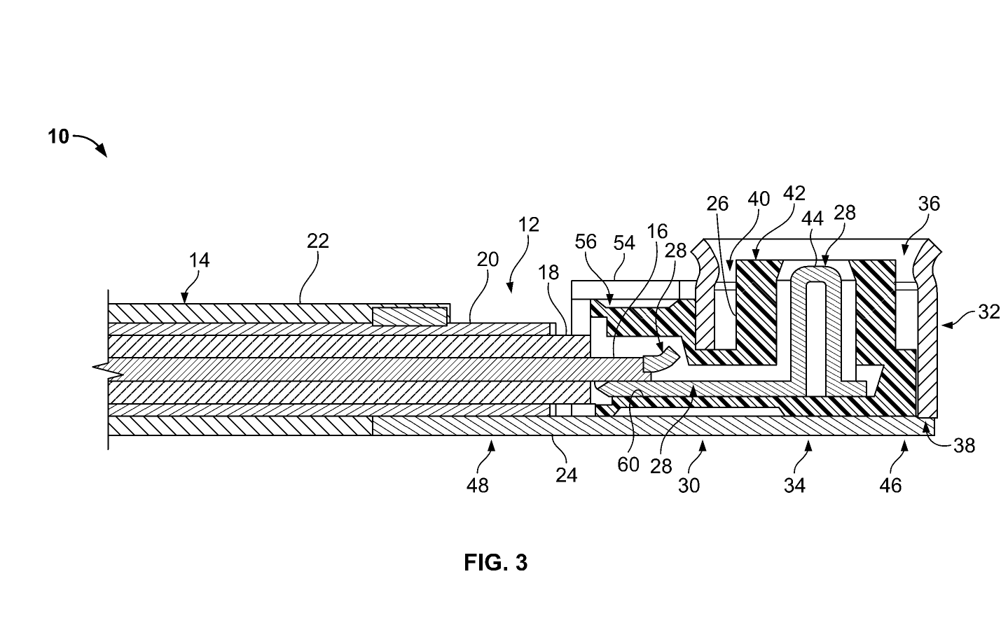

FIGS. 1 and 2 are perspective views of an exemplary embodiment of an electrical connector 10 illustrating the electrical connector 10 terminating the end 12 of a coaxial cable 14. FIG. 3 is a cross-sectional view of the electrical connector 10 and coaxial cable 14 taken along line 3-3 of FIG. 1. The coaxial cable 14 includes an inner electrical conductor 16, an insulating member 18 surrounding the inner electrical conductor 16, an outer electrical conductor 20 surrounding the insulating member 18, and an insulating cover 22 surrounding the outer electrical conductor 20. In the exemplary embodiment, the inner electrical conductor 16 is a signal path while the outer electrical conductor 20 is a ground path. However, alternatively the inner electrical conductor 16 may be a ground path while the outer electrical conductor 20 is a signal path.

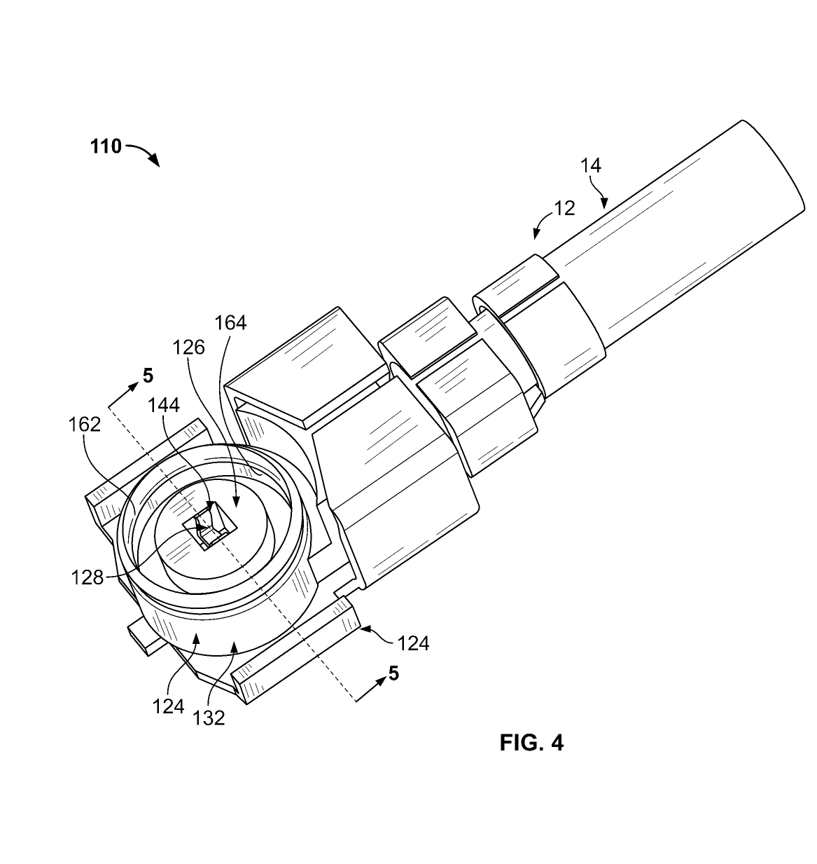

The electrical connector 10 includes an electrically conductive housing 24, an insulating member 26 held by the electrically conductive housing 24, and an electrical contact 28 held by the insulating member 26. The electrically conductive housing 24 includes a body 30 having a main contact portion 32 and a base 34. The main contact portion 32 extends between a pair of opposite end portions 36 and 38 and defines a receptacle 40. A portion 42 of the insulating member 26 of the electrical connector 10 is held within the receptacle 40 of the main contact portion 32. The insulating member 26 holds a plug contact 44 of the electrical contact 28 within the receptacle 40 and electrically isolates the electrical contact 28 from the main contact portion 32 of the electrically conductive housing 24 as well as portions of the base 34. The plug contact 44 is configured to be received by a receptacle contact (such as, but not limited to, the receptacle contact 144 shown in FIGS. 4 and 5) of another electrical connector (such as, but not limited to, the electrical connector 110 shown in FIGS. 4 and 5) that is configured to mate with the electrical connector 10. Similarly, the main contact portion 32 is configured to engage the main contact portion (such as, but not limited to, the main contact portion 132 shown in FIGS. 4 and 5) of the other electrical connector. In some embodiments, the other electrical connector is mounted on a substrate, such as, but not limited to, a circuit board, a panel, and/or the like. In other embodiments, the other electrical connector terminates the end of another coaxial cable (not shown).

The base 34 extends between a pair of opposite end portions 46 and 48. When assembled as shown in FIGS. 1-3, the end portion 46 of the base 34 covers, or closes, the end portion 38 (which is initially open) of the main contact portion 32 and the base 34 extends outwardly from the main contact portion 32 along the coaxial cable 14. The base 34 of the electrically conductive housing 24 includes a pair of opposite cover tabs 50, a pair of opposite ground tabs 52, and a pair of opposite retention tabs 54. The cover tabs 50 extend outwardly from opposite side portions of the base 34 to corresponding free end portions. When the housing 24 is assembled as shown in FIGS. 1-3, the free end portions oppose one another. Alternatively, the base 34 may include only one cover tab (not shown) that extends from either of the side portions to an end portion that opposes the other side portion. Moreover, the base 34 may alternatively include a continuous cover tab (not shown) that extends from both side portions. Although two cover tabs 50 are shown, the base 34 may include any number of cover tabs 50 extending therefrom.

The insulating member 26 includes an extension 56 that extends outwardly from the portion 42 of the insulating member 26 and is received within an extension (not shown) of the main contact portion 32 of the electrically conductive housing 24. When assembled as shown in FIGS. 1-3, the extension 56 and the extension of the main contact portion 32 extend outwardly from the insulating member portion 42 and the main contact portion 32, respectively, along the base 34 toward the end portion 48 of the base 34. The retention tabs 54 of the base 34 engage the extension of the main contact portion 32 of the housing 24 to retain the main contact portion 32 in the position with respect to the base 34 that is shown in FIGS. 1-3. In the exemplary embodiments, the retention tabs 54 extend outwardly from opposite side portions of the base 34 to corresponding free end portions. When the housing 24 is assembled as shown in FIGS. 1-3, the free end portions oppose one another. Alternatively, the base 34 may include only one retention tab (not shown) that extends from either of the side portions to an end portion that opposes the other side portion. Although two retention tabs 54 are shown, the base 34 may include any number of retention tabs 54 extending therefrom.

As shown in FIGS. 1-3, at the end 12 of the coaxial cable 14, the outer electrical conductor 20 is exposed from the insulating cover 22, the insulating member 18 is exposed from the outer electrical conductor 20, and the inner electrical conductor 16 is exposed from the insulating member 18. The coaxial cable end 12 engages the base 34 of the electrically conductive housing 24 such that the cover tabs 50 of base 34 engage the insulating cover 22 to facilitate securing the coaxial cable 14 to the electrical connector 10. The ground tabs 52 engage the exposed portion of the outer electrical conductor 20 to electrically connect the outer electrical conductor 20 of the coaxial cable 14 to the electrically conductive housing 24 and to facilitate securing the coaxial cable 14 to the electrical connector 10. In the exemplary embodiments, the ground tabs 52 extend outwardly from opposite side portions of the base 34 to corresponding free end portions. When the housing 24 is assembled as shown in FIGS. 1-3, the free end portions oppose one another. Alternatively, the base 34 may include only one ground tab (not shown) that extends from either of the side portions to an end portion that opposes the other side portion. Moreover, the base 34 may alternatively include a continuous ground tab (not shown) that extends from both side portions. Although two ground tabs 52 are shown, the base 34 may include any number of ground tabs 52 extending therefrom.

As can be seen in FIG. 3, the extension 56 of the insulating member 26 holds a portion of the electrical contact 28 within an opening 60 of the insulating member 26 and electrically isolates the electrical contact 28 from the base 34 and the main contact portion 32 of the electrically conductive housing 24. As will be described in more detail below, the electrical contact 28 engages the exposed portion of the inner electrical conductor 16 of the coaxial cable to electrically connect the electrical contact 28 with the inner electrical conductor. In the exemplary embodiment, the electrically conductive housing 24 is a ground path, while the electrical contact 28 is a signal path. Alternatively, the electrically conductive housing 24 is a signal path and the electrical contact 28 is a ground path.

The main contact portion 32 of the electrically conductive housing 24 may optionally include a groove 62 extending within a radially outer surface 64 of the main contact portion 32 that cooperates with an extension (e.g., the extension 164 shown in FIG. 4) of another electrical connector that is configured to mate with the electrical connector 10. Cooperation between the groove 62 and the extension creates a snap-fit connection that may facilitate holding the two electrical connectors together. Additionally or alternatively, the main contact portion 32 of the electrically conductive housing 24 may optionally include an extension (not shown) extending outwardly from the radially outer surface 64 that cooperates with a groove (not shown) of another electrical connector that is configured to mate with the electrical connector 10. Moreover, the main contact portion 32 of the electrically conductive housing 24 may alternatively include a groove (not shown) or an extension (not shown) extending on a radially inner surface of the main contact portion 32 that cooperates with a respective extension or groove of another electrical connector that is configured to mate with the electrically connector 10.

Although the electrical connector 10 is described and illustrated herein as including a plug contact 44, the electrical connector 10 may alternatively include a receptacle contact. FIG. 4 is a perspective view of an exemplary alternative embodiment of an electrical connector 110 illustrating the electrical connector 110 terminating the end 12 of the coaxial cable 14. FIG. 5 is a cross-sectional view of the electrical connector 110 and coaxial cable 14 taken along line 5-5 of FIG. 4. The electrical connector 110 includes an electrically conductive housing 124, an insulating member 126 held by the electrically conductive housing 124, and an electrical contact 128 held by the insulating member 126. The electrically conductive housing 124 is electrically connected to the outer electrical conductor 20 (FIG. 3) of the coaxial cable 14, while the electrical contact 128 is electrically connected to the inner electrical conductor 16 (FIG. 3) of the coaxial cable 14. In contrast to the plug contact 44 (FIGS. 1-3) of the electrical contact 28 (FIGS. 1-3, 6, and 8-10), the electrical contact 128 includes a receptacle contact 144 that is configured to receive a plug contact (e.g., the plug contact 44 shown in FIGS. 1-3, 6, and 8-10) of another electrical connector (e.g., the electrical connector 10 shown in FIGS. 1-3) that is configured to mate with the electrical connector 110.

A main contact portion 132 of the electrically conductive housing 124 may optionally include an extension 162 extending outwardly from a radially inner surface 164 of the main contact portion 132 that cooperates with a groove (e.g., the groove 64 shown in FIGS. 1 and 2) of another electrical connector that is configured to mate with the electrical connector 110. Cooperation between the extension 162 and the groove creates a snap-fit connection that may facilitate holding the two electrical connectors together. Additionally or alternatively, the main contact portion 132 of the electrically conductive housing 124 may optionally include a groove (not shown) extending within the radially inner surface 164 that cooperates with an extension (not shown) of another electrical connector that is configured to mate with the electrical connector 110.

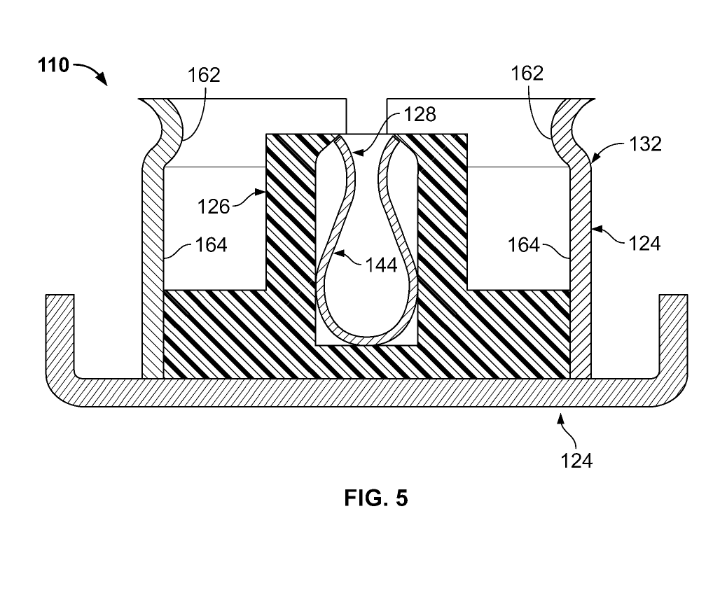

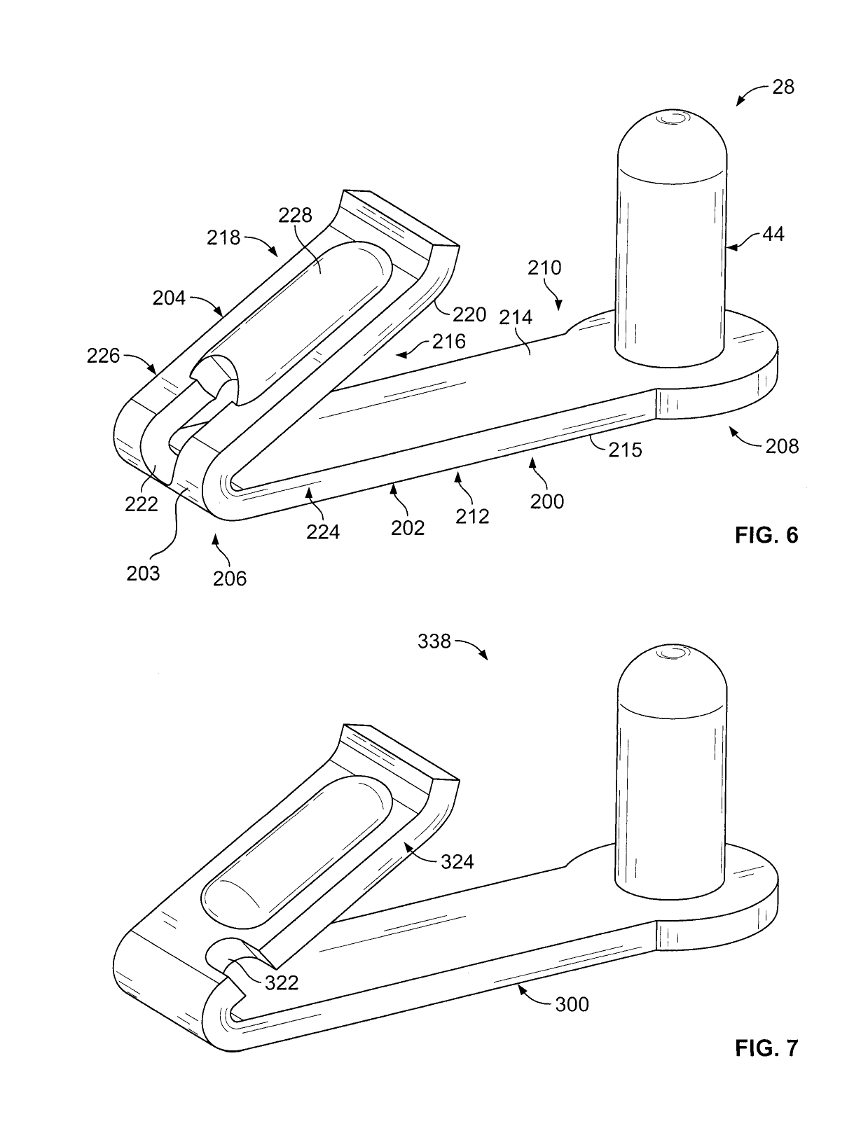

FIG. 6 is a perspective view of an exemplary embodiment of the electrical contact 28 of the electrical connector 10 (FIGS. 1-3). The electrical contact 28 includes a body 200 that includes an element 202 and an element 204. The element 202 extends between a cable receiving end portion 206 and an opposite contact end portion 208. The element 202 includes a pair of opposite side portions 210 and 212. The side portion 210 includes the plug contact 44 extending outwardly from a surface 214 of the side portion 210 at the contact end portion 208. Alternatively, the side portion 210 includes a receptacle contact (e.g., the receptacle contact 144 shown in FIGS. 4 and 5) extending outwardly therefrom. Moreover, in alternative to the side portion 210, the side portion 212 may include the plug contact 44 or a receptacle contact extending outwardly from a surface 215 of the side portion 212. Although in the illustrated embodiment the portion 208 is an end portion of the element 202 such that the plug contact 44 extends from an end portion of the element 202, alternatively the plug contact 44 may extend from a portion of the element 202 that is not an end portion of the element 202. The surface 214 of the side portion 210 of the element 202 engages the inner electrical conductor 16 (FIGS. 1-5 and 8-10) of the coaxial cable 14 (FIGS. 1-5 and 8-10), as will be described below.

The element 204 extends from the cable receiving end portion 206 of the element 202. The element 204 includes a pair of opposite side portions 216 and 218. As described below, the side portion 216 includes a surface 220 that engages the inner electrical conductor 16 of the coaxial cable 14 such that the elements 202 and 204 hold a portion of the inner electrical conductor 16 therebetween. As illustrated in FIG. 6, the element 204 extends outwardly from the cable receiving end portion 206 of the element 202 in a direction generally toward the contact portion 208 of the element 202. Prior to assembly of the electrical connector 10, and more specifically prior to termination of the inner electrical conductor 16 of the coaxial cable 14 to the electrical contact 28, the element 204 extends at an angle of approximately 9° or less with respect to the element 202. The angle of the element 204 with respect to the element 202 prior to termination of the inner electrical conductor 16 to the electrical contact 28 may be selected to facilitate termination operations, such as, but not limited to, crimping of the elements 202 and 204 together, which is described below.

In the illustrated embodiment, the body 200 of the electrical contact 28 includes an opening 222 extending through the body 200 adjacent the cable receiving end portion 206 of the element 202. As described below, the opening 222 receives a portion of the inner electrical conductor 16 of the coaxial cable 15 therethrough. Although shown as having an approximately oval shape, the opening 222 may have any suitable shape and/or size that enables the opening 222 to function as described herein. Moreover, although the opening 222 is illustrated as extending between, but not through, opposite side portions 224 and 226 of the body 200, the opening 222 is not so limited by the illustrated arrangement and rather may extend through one of the side portions 224 or 226. For example, FIG. 7 illustrates an exemplary alternative embodiment of an electrical contact 328 that includes an opening 322 that extends through a side portion 324 of a body 300 of the electrical contact 328. Similar to the opening 222, the opening 322 receives a portion of the inner electrical conductor 16 of the coaxial cable 14 therethrough. Referring again to FIG. 6, in a further alternative embodiment the body 200 of the electrical contact 28 does not include the opening 222, such that a portion of the inner electrical conductor 16 of the coaxial cable 14 is configured to be wrapped around one of the side portions 224 or 226 in order to be received between the elements 202 and 204 as described below.

In the illustrated embodiment, the surface 220 of the element 204 includes an optional depression 228 therein. Additionally or alternatively, the surface 214 of the element 202 optionally includes the depression 228 therein. The depression 228 is sized and shaped complementary to the inner electrical conductor 16 of the coaxial cable 14 such that the depression 228 receives a portion of the inner electrical conductor 16 therein when the elements 202 and 204 hold the inner electrical conductor 16 therebetween. The depression 228 may have any suitable size, shape, and/or location along the element 204 that enables the depression 228 to function as described herein. In the illustrated embodiment, the depression 228 includes an arcuate shape.

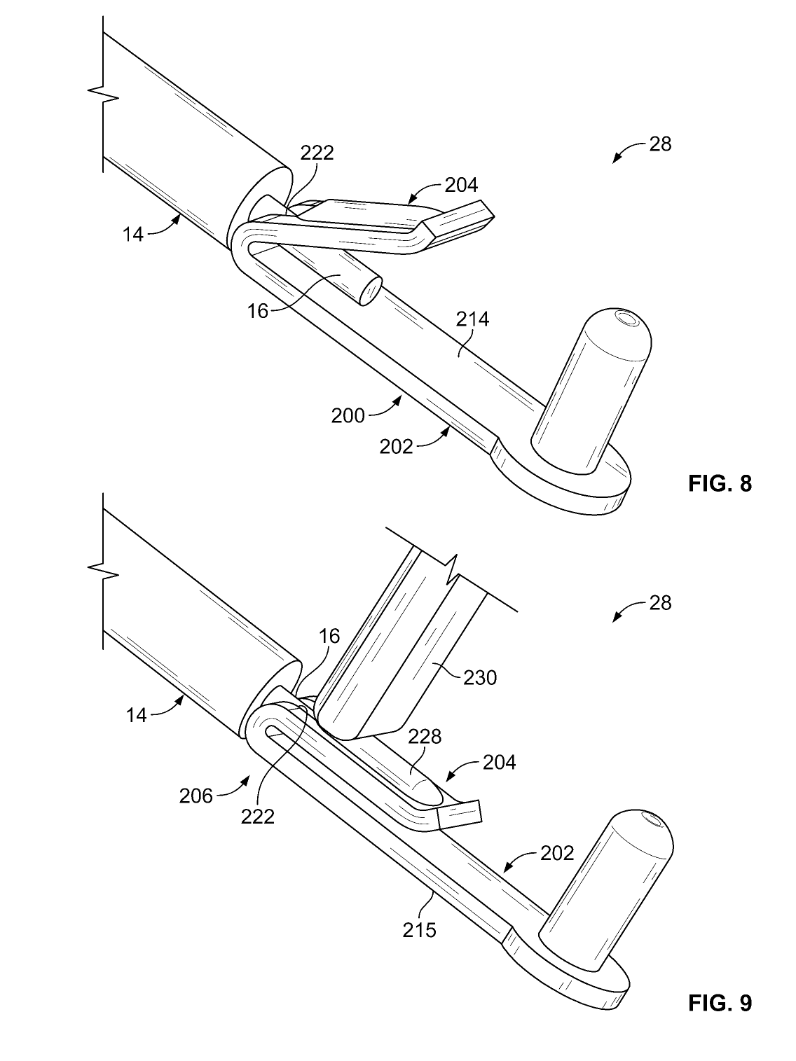

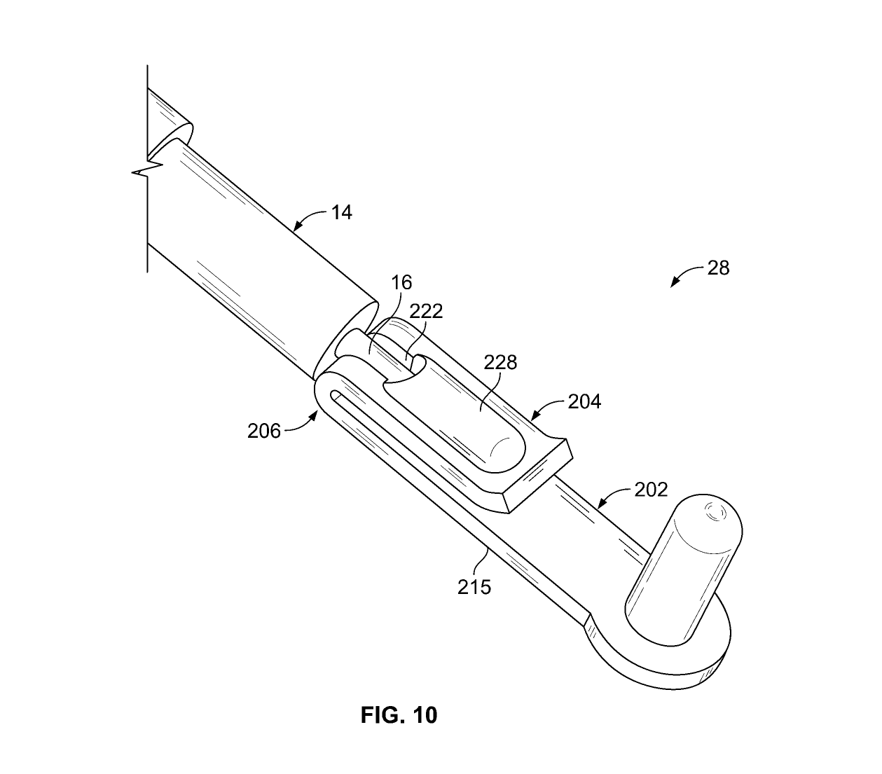

FIG. 8 is a perspective view of the electrical contact 28 illustrating the electrical contact 28 in partial engagement with the inner electrical conductor 16 of the coaxial cable 14. As shown in FIG. 8, the exposed portion of the inner electrical conductor 16 is received within the opening 222 of the body 200 such that the exposed portion of the inner electrical conductor 16 is engaged with the surface 214 of the element 202. To terminate the inner electrical conductor 16 to the electrical contact 28, the elements 202 and 204 are brought together (such as, but not limited to, crimped) as shown in FIG. 9 and 10 such that the elements 202 and 204 hold the exposed portion of the inner electrical conductor 16 therebetween and such that the inner electrical conductor 16 extends through the opening 222 and the coaxial cable 14 extends outwardly from the cable receiving end portion 206 of the element 202. As is evident from FIGS. 9 and 10, a portion of the inner electrical conductor 16 is received within the depression 228 when the inner electrical conductor 16 is terminated to the electrical contact.

The inner electrical conductor 16 may be terminated to the electrical contact 28 as shown in FIGS. 9 and 10 before, during, or after the connector 10 is assembled. For example, the inner electrical conductor 16 may be terminated to the electrical contact 28 before, during, or after the insulating member 26 (FIGS. 1-3) is inserted into the receptacle 40 (FIGS. 1-3) of the main contact portion 32 (FIGS. 1-3) of the electrically conductive housing 24 (FIGS. 1-3).

The elements 202 and 204 may be brought together, such as, but not limited to, crimped, using any suitable tool and/or component of the electrical connector 10. For example, in some embodiments, the elements 202 and 204 are brought together using a crimping tool 230. Moreover, in embodiments wherein the plug contact 44 extends from the surface 215 of the element 202, a portion of the insulating member 26 may engage the element 204 and force the element 204 toward the element 202 and into engagement with the inner electrical conductor 16 during assembly of the electrically conductive housing 24, and more specifically during folding of the base 34 of the housing 24, and the portion of the insulating member 26 engaging the element 204, with respect to the main contact portion 32 of the housing 24.

The embodiments described and/or illustrated herein provide a coaxial cable connector that may enable a coaxial cable to be more easily terminated to the coaxial cable connector. For example, the embodiments described and/or illustrated herein provide a coaxial cable connector that may enable a coaxial cable to be terminated to the coaxial cable connector using generic tools and/or fewer operations than at least some known coaxial cable connectors.

Exemplary embodiments are described and/or illustrated herein in detail. The embodiments are not limited to the specific embodiments described herein, but rather, components and/or steps of each embodiment may be utilized independently and separately from other components and/or steps described herein. Each component, and/or each step of one embodiment, can also be used in combination with other components and/or steps of other embodiments. When introducing elements/components/etc. described and/or illustrated herein, the articles “a”, “an”, “the”, “said”, and “at least one” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc. Moreover, the terms “first,” “second,” and “third,” etc. in the claims are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

While the subject matter described and/or illustrated herein has been described in terms of various specific embodiments, those skilled in the art will recognize that the subject matter described and/or illustrated herein can be practiced with modification within the spirit and scope of the claims.

1. An electrical contact for terminating an electrical conductor of a coaxial cable, said electrical contact comprising:
a body comprising a first element extending between a cable receiving end portion and a contact portion, the first element comprising a first surface configured to engage the electrical conductor;
a second element extending from the cable receiving end portion of the first element at a hinge, the second element comprising a second surface configured to engage the electrical conductor; and
an opening extending through the second element at least one of adjacent the hinge and through the hinge, wherein the first and second elements are configured to hold a portion of the electrical conductor therebetween such that the electrical conductor extends through the opening and outwardly from the cable receiving end portion of the first element.

2. The electrical contact according to claim 1, wherein the first element extends a length along a longitudinal axis, the first and second elements being configured to hold a portion of the electrical conductor therebetween such that the electrical conductor extends substantially parallel to the longitudinal axis of the first element.

3. The electrical contact according to claim 1, wherein the first element extends a length along a longitudinal axis, the second element extending outwardly from the cable receiving end portion of the first element in a direction that extends along the longitudinal axis.

4. The electrical contact according to claim 1, wherein the first element extends a length along a longitudinal axis, the second element being pivotable about the hinge between an unclamped position wherein the second surface is not engaged with the electrical conductor and a clamped position wherein the second surface is engaged with the electrical conductor, the second element being angled relative to the longitudinal axis in the unclamped position, the second element extending substantially parallel to the longitudinal axis in the clamped position.

5. The electrical contact according to claim 1, wherein at least one of the second surface of the second element and the first surface of the first element comprises a depression therein, the depression configured to receive a portion of the electrical conductor therein.

6. The electrical contact according to claim 5, wherein the depression comprises an arcuate shape.

7. The electrical contact according to claim 1, wherein the contact portion of the first element comprises an end portion of the first element.

8. The electrical contact according to claim 1, wherein the contact portion of the first element comprises one of a plug contact and a receptacle contact.

9. The electrical contact according to claim 1, wherein the first element comprises a plug contact extending outwardly from the first surface at the contact portion of the first element.

10. The electrical contact according to claim 1, wherein the second element comprises a tip, the second element extending outwardly from the first element to the tip, the second element being movable from an unclamped position wherein the second surface is not engaged with the electrical conductor to a clamped position wherein the second surface is engaged with the electrical conductor, the tip of the second element moving closer to the contact portion of the first element when the second element is moved from the unclamped position to the clamped position.

11. An electrical connector for terminating an electrical conductor of a coaxial cable, said electrical connector comprising:
an electrically conductive housing;
an insulating member held by the housing; and
an electrical contact held by the insulating member, the electrical contact comprising a body comprising:
a first element extending along a longitudinal axis between a cable receiving end portion and a contact portion, the first element comprising a first surface configured to engage the electrical conductor; and
a second element extending from the cable receiving end portion of the first element at a hinge, the second element comprising a second surface configured to engage the electrical conductor, the second element being pivotable about the hinge between an unclamped position wherein the second surface is not engaged with the electrical conductor and a clamped position wherein the second surface is engaged with the electrical conductor, the second element being angled relative to the longitudinal axis in the unclamped position, the second element extending outwardly from the hinge in a direction substantially parallel to the longitudinal axis in the clamped position.

12. The electrical connector according to claim 11, wherein the body of the electrical contact further comprises an opening extending through the second element at least one of adjacent the hinge and through the hinge, the opening configured to receive a portion of the electrical conductor therethrough.

13. The electrical connector according to claim 11, wherein the cable receiving end portion of the first element comprises an edge, the first element extending a length from the contact portion to the edge of the cable receiving end portion, the second element extending outwardly from the edge of the cable receiving end portion.

14. The electrical connector according to claim 11, wherein the first element the first and second elements are configured to hold a portion of the electrical conductor therebetween such that the electrical conductor extends substantially parallel to the longitudinal axis of the first element.

15. The electrical connector according to claim 11, wherein at least one of the second surface of the second element and the first surface of the first element comprises a depression therein, the depression configured to receive a portion of the electrical conductor therein.

16. (canceled)

17. The electrical connector according to claim 11, wherein the contact portion of the first element comprises an end portion of the first element.

18. The electrical connector according to claim 11, wherein the first element comprises one of a plug contact and a receptacle contact.

19. The electrical connector according to claim 11, wherein the first element extends a length along a longitudinal axis, the second element extending outwardly from the cable receiving end portion of the first element in a direction that extends along the longitudinal axis.

20. The electrical connector according to claim 11, wherein the second element comprises a tip, the second element extending outwardly from the first element to the tip, the second element being movable from a unclamped position wherein the second surface is not engaged with the electrical conductor to a clamped position wherein the second surface is engaged with the electrical conductor, the tip of the second element moving closer to the contact portion of the first element when the second element is moved from the unclamped position to the clamped position.

21. An electrical contact for terminating an electrical conductor of a coaxial cable, said electrical contact comprising:
a body comprising a first element extending a length between a cable receiving edge and a contact portion, the first element comprising a first surface configured to engage the electrical conductor; and
a second element extending outwardly from the cable receiving edge of the first element, the second element comprising a second surface configured to engage the electrical conductor, wherein the first and second elements are configured to hold a portion of the electrical conductor therebetween such that the coaxial cable extends outwardly from the cable receiving edge of the first element.
